(19) United States
(12) Patent Application Publication
(10) Pub. No.: US 2013/0336786 A1
(43) Pub. Date: Dec. 19, 2013

(54) Automatic Inspection of a Lightning Protection System on a Wind Turbine

(71) Applicant: Joshua Paul Kissinger, Santa Barbara, CA (US)

(72) Inventor: Joshua Paul Kissinger, Santa Barbara, CA (US)

(73) Assignee: Clipper Windpower, LLC, Carpinteria, CA (US)

(21) Appl. No.: 13/526,098

(22) Filed: Jun. 18, 2012

(51) Int. Cl. F03D 11/00

(52) U.S. Cl. 416/1; 416/61

(57) ABSTRACT

A system and method for automatically inspecting a lightning protection system on a wind turbine is disclosed. The system and method may include a wind turbine having a plurality of blades mounted to a hub, a lightning receptor on each of the plurality of blades, a lightning protection system extending from each of the lightning receptor to an earth grounding grid and a conductor that is part of a testing system extending from at least inside the hub, through the inside of at least one of the plurality of blades and connecting to the lightning receptor, the conductor completing a circuit extending from the lightning receptor to the earth grounding grid. A test current signal may be introduced into the testing system for a leg of the lightning protection system to be tested and an electrical continuity in the circuit using the test current signal may be determined.

### FIELD OF THE DISCLOSURE

The present disclosure relates generally to wind turbines and, more particularly, relates to a system and method for automatically inspecting a lightning protection system on a wind turbine.

### BACKGROUND OF THE DISCLOSURE

A utility-scale wind turbine typically includes a set of two or three large rotor blades mounted to a hub. The rotor blades and the hub together are referred to as the rotor. The rotor blades aerodynamically interact with the wind and create lift, which is then translated into a driving torque by the rotor. The rotor is attached to and drives a main shaft, which in turn is operatively connected via a drive train to a generator or a set of generators that produce electric power. The main shaft, the drive train and the generator(s) are all situated within a nacelle, which is situated on top of a tower.

A utility-scale wind turbine also typically includes a lightning protection system. Wind turbines are frequently struck by lightning, which can cause significant damage to components of the wind turbine. Not only can the various electrical components and electronics within the wind turbine be damaged by the high voltage and large currents of a lightning strike, mechanical components, such as pitch bearings, can also be damaged. Lightning current passing through a bearing can cause localized pitting and other damage due to the high current and heat. Therefore, to protect wind turbine components from lightning strikes, lightning protection systems are employed. These systems conduct current from a lightning strike to the surrounding earth via a pathway that directs the current away from sensitive or at risk wind turbine components to prevent damage.

Lightning protection systems generally include lightning receptors on the distal ends of the rotor blades, and lightning rods on the nacelle. The receptors and rods are intended to be the points where the lightning strike attaches to the wind turbine from the air. The receptors and rods are in turn grounded through cables and structural connections to the foundation, and ultimately to the surrounding earth to safely conduct the lightning current from the lightning strike away from the wind turbine.

To ensure that the lightning protection systems are in proper working order, and available to effectively conduct the lightning current from a lightning strike, they are periodically inspected and tested. One aspect of the inspection is to test electrical continuity from the receptors and rods to the ground, and measure and confirm that the resistance is at or below a minimum specified threshold. The resistance can increase over time due to wear on certain components in the conductive pathway. For example, brushes are used to create a conductive pathway between structures that rotate relative to one another, such as between the hub and the nacelle. Over time, the brushes can wear and the resistance through the brushes may increase. The periodic inspection identifies when wear and tear or other damage has affected the lightning protection system, so that repair personnel can repair and restore the system's functionality.

Conventionally, the periodic inspection of a lightning protection system is conducted manually, with several personnel and heavy equipment necessary for the procedure. One method for conducting a part of the inspection requires the wind turbine rotor to be stopped, with the rotor blade to be inspected positioned in a six o'clock position. After the rotor is stopped, with the rotor blade locked in the six o'clock position, a lift truck can be positioned below the rotor blade. Then, a man basket with a technician can be lifted to the position of the lightning receptors on the rotor blade. The technician can carry one lead of a continuity testing device to the lightning receptor, while the other lead can be connected to the wind turbine earth grounding grid. By contacting one lead to the lightning receptor and the other lead to the earth grounding grid, the technician is able to complete a LPS testing system from the lightning receptor to the earth grounding grid, and test continuity of this portion of the lightning protection system. Resistance within the circuit can be measured to confirm that it lies within specification (e.g., below a specified threshold). The above process for completing an electric circuit and measuring resistance to establish continuity in the circuit can be repeated with each of the blades.

This manual inspection technique suffers from several disadvantages. First, several technicians are required to stop the wind turbine rotor, position and lock the rotor blades in place, perform the continuity test, operate the lift truck, record the results, and report them. This technician time comes at a high cost. Second, the results of the inspection are also prone to errors resulting from human intervention. Third, the cost of deploying the lift truck can be substantial. Fourth, the wind turbine must be offline for the length of time necessary to complete the inspection, and this downtime results in a loss of power production and therefore profits for the wind turbine owner. Thus, the overall cost of performing a manual inspection of a lightning protection system on a wind turbine can be very high.

Accordingly, it would be beneficial if an automatic technique for inspecting a lightning protection system on a wind turbine could be developed that could overcome at least some of the disadvantages associated with manual inspection techniques.

### SUMMARY OF THE DISCLOSURE

In accordance with one aspect of the present disclosure, a method for automatically inspecting a lightning protection system on a wind turbine is disclosed. The method may include providing a wind turbine having a plurality of blades mounted to a hub, a lightning receptor on a tip of each of the plurality of blades, a lightning protection system extending from each of the lightning receptor to an earth grounding grid and a conductor that is part of a testing system extending from at least inside the hub, through the inside of at least one of the plurality of blades and connecting to the lightning receptor, the conductor completing a circuit extending from the lightning receptor to the earth grounding grid. The method may also include introducing a test signal into the testing system for a leg of the lightning protection system to be tested and determining an electrical continuity in the circuit using the test signal.

In accordance with another aspect of the present disclosure, an inspection system for a lightning protection system on a wind turbine is disclosed. The inspection system may include a lightning protection system extending from a lightning receptor on a blade of the wind turbine to an earth grounding grid and a testing system connected to the lightning receptor on the blade of the wind turbine and to the earth grounding grid to form a testing circuit, the testing system being located generally inside of the wind turbine.

In accordance with yet another aspect of the present disclosure, a method for performing a continuity test on a lightning protection system on a wind turbine is disclosed. The method may include connecting a testing system to a lightning receptor mounted on the exterior, distal end of a rotor blade of a wind turbine on one end, and connecting the testing system to an earth grounding grid on the other end, the earth grounding grid also connected to the lightning receptor to form a lightning protection system for conducting current from lightning strikes to the earth and simultaneously sending a test signal from the testing system between the lightning receptor and the earth grounding grid to test continuity while allowing the rotor of the wind turbine to rotate.

Other advantages and features will be apparent from the following detailed description when read in conjunction with the attached drawings.

### BRIEF DESCRIPTION OF THE DRAWINGS

For a more complete understanding of the disclosed methods and apparatuses, reference should be made to the embodiments illustrated in greater detail on the accompanying drawings, wherein:

FIG. 1 is a schematic illustration of a wind turbine, in accordance with at least some embodiments of the present disclosure;

FIG. 2 is a schematic illustration of a lightning protection system and an automatic inspection system that may be employed within the wind turbine of FIG. 1; and

FIG. 3 is a flowchart outlining steps that may be performed in automatically inspecting the lightning protection system of FIG. 2 by utilizing the automatic inspection system.

While the following detailed description has been given and will be provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims eventually appended hereto.

### DETAILED DESCRIPTION OF THE DISCLOSURE

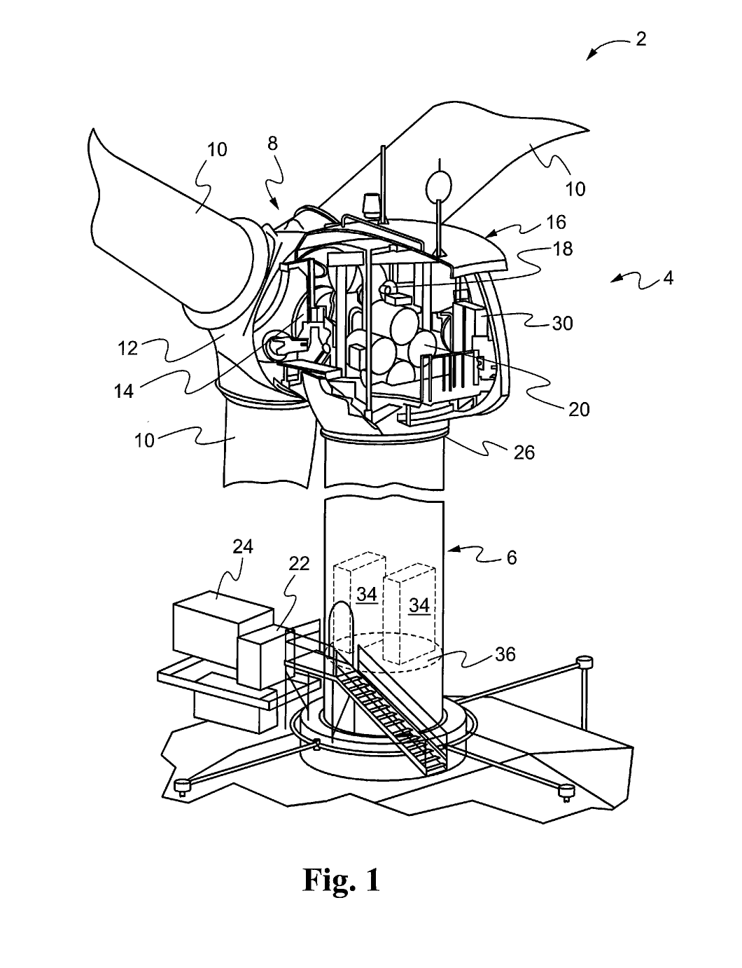

Referring now to FIG. 1, an exemplary wind turbine 2 is shown, in accordance with at least some embodiments of the present disclosure. While all the components of the wind turbine have not been shown and/or described, a typical wind turbine may include an up tower section 4 and a down tower section 6. The up tower section 4 may include a rotor 8, which in turn may include a plurality of blades 10 connected to a hub 12. The blades 10 may rotate with wind energy and the rotor 8 may transfer that energy to a main shaft 14 situated within a nacelle 16. The nacelle 16 may additionally include a drive train or gearbox 18, which may connect the main shaft 14 on one end to one or more generators 20 on the other end. The generators 20 generate electrical power, which may be transmitted from the up tower section 4 through the down tower section 6 to a power distribution panel (PDP) 22 and a pad mount transformer (PMT) 24 for transmission to a grid (not shown). The PDP 22 and the PMT 24 may also provide electrical power from the grid to the wind turbine for powering several auxiliary components thereof.

In addition to the components of the wind turbine 2 described above, the up tower section 4 of the wind turbine may include several auxiliary components, such as, a yaw system 26 on which the nacelle 16 may be positioned to pivot and orient the wind turbine in a direction of the wind current or another preferred direction, a pitch control unit (PCU) (not visible) situated within the hub 12 for controlling the pitch (e.g., angle of the blades with respect to the wind direction) of the blades 10, a hydraulic power system (not visible) to provide hydraulic power to various components such as brakes of the wind turbine, and a cooling system (also not visible). In addition to the auxiliary components of the wind turbine 2 described above, it will be understood that the wind turbine 2 may include several other auxiliary components that are contemplated and considered within the scope of the present disclosure. Furthermore, a turbine control unit (TCU) 30 may be situated within the nacelle 16 for controlling the various components of the wind turbine 2.

With respect to the down tower section 6 of the wind turbine 2, among other components, the down tower section may include a pair of generator control units (GCUs) 34 and a down tower junction box (DJB) 36 for routing and distributing power between the wind turbine and the grid. Several other components, such as, ladders, access doors, etc., that may be present within the down tower section 6 of the wind turbine 2 are contemplated and considered within the scope of the present disclosure.

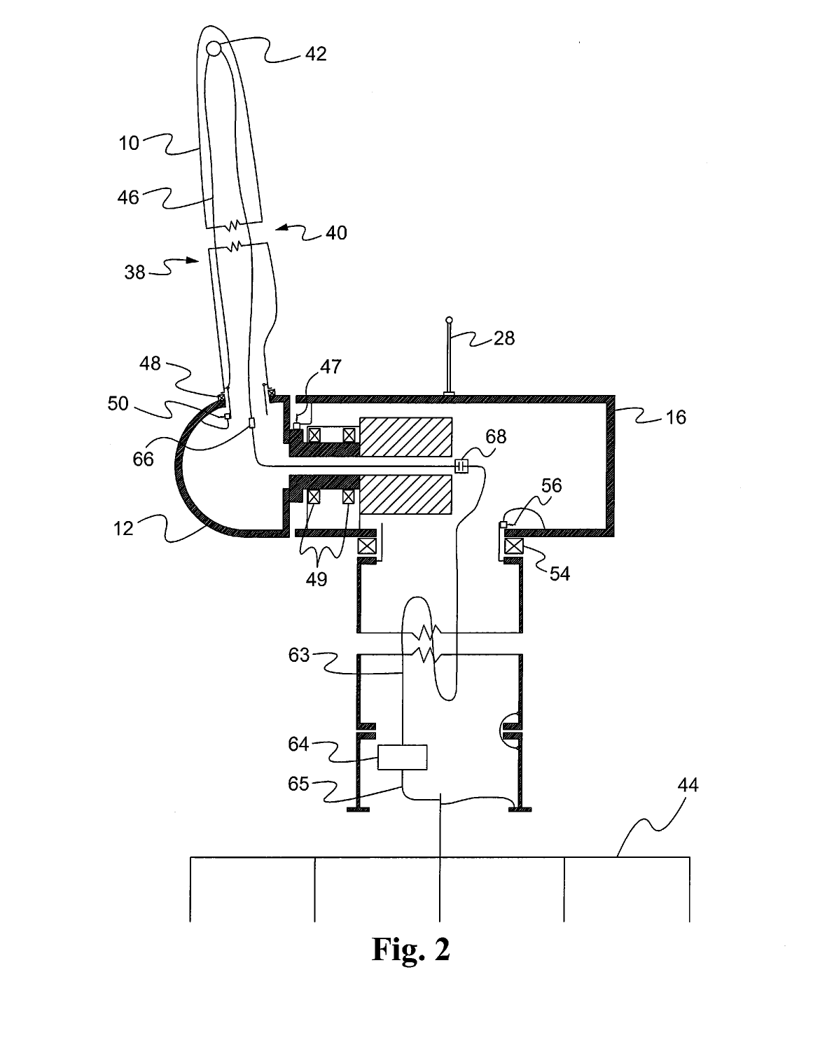

Referring now to FIG. 2, exemplary schematic illustrations of a lightning protection system (LPS) 38 for the wind turbine 2 and an LPS testing system 40 for automatically inspecting the LPS are shown, in accordance with at least some embodiments of the present disclosure. The LPS 38 may also be referred to as a lightning grounding system. It will be understood that both the LPS 38 and the LPS testing system 40 have been shown and described in FIG. 2 with respect to only one of the plurality of blades (also referred to herein as simply a blade or blades) 10 of the wind turbine 2. However, the LPS 38 and the LPS testing system 40 may be present on each of the plurality of blades 10. Thus, for the wind turbine 2 having three of the blades 10, three legs (one for each of the blades) of the LPS 38 and three legs of the LPS testing system 40, may be present. The LPS 38 and the LPS testing system 40 may each include additional components and hardware as will be understood by those or ordinary skill in this art, and need not be described in detail herein.

With respect to the LPS 38, as discussed above, it may be employed to protect the wind turbine 2 and components thereof from any lightning that may strike the wind turbine. Accordingly, the LPS 38 may include a lightning rod 28 mounted to the top of the nacelle 16. The LPS 38 may also have a lightning receptor 42 (or a plurality of the same) on the tip of each of the plurality of blades 10 to attract and catch the lightning strike and to, ultimately, transmit the lightning current safely to an earth grounding grid 44. The lightning receptor(s) 42 are typically mounted so that it is recessed into and flush with the surface of the blades 10. In addition to the lightning receptor(s) 42, conductive lightning collector strips may be mounted on the surface of the blades 10 to bring lightning strikes to the lightning receptor(s). Each leg of the LPS 38 in each of the blade 10 may include an electrical conductor 46 extending from the lightning receptor(s) 42 on the end of each blade, through the inside of the blade, and to the root of the blade where the blade attaches to the hub 12 via a pitch bearing 48. From the hub 12, the current of the lightning strike may be routed through structural steel components of the wind turbine 2, such as the hub, wind turbine machine base and tower sections, while avoiding passing through sensitive components such as bearings, as further described below.

To conduct the lightning current across the pitch bearing 48 and between the blade 10 and the hub 12 while the blade rotates relative to the hub, a brush assembly 50 may be used. Brush assemblies are used for this purpose in all types of rotating electric machinery to ensure a lower resistance pathway around a sensitive component and need not be described in full detail. The electrical conductor 46 may be connected to a disc surface of some type that rotates with the blade 10 around the axis of the pitch bearing 48. Inside the hub 12, a brush may be spring-biased against the disc to form a conductive circuit between the two. The brush, or brush holder, in turn may have a short conducting wire extending from it connected and grounded to the steel structure of the hub 12. Thus, the lightning current travels from the electrical conductor 46, through the brush assembly 50 and then through the steel structure of the hub 12. Alternatively, the brush may also be mounted to the blade 10 and the disc to the hub 12. Instead of a disc as illustrated schematically in FIG. 2, a surface of the bearing raceway may be used to contact the brush. Many different arrangements for the brush assembly 50 are possible and may be present on a wind turbine.

To conduct the lightning current from the steel structure of the hub 12 to the steel structure of the nacelle 16 and around a main shaft bearing 49, a second brush assembly 47 may be used. In this case, a rotating disc may be attached to the steel structure of the hub 12 as illustrated in FIG. 2. A brush that is stationary with the nacelle structure is spring biased against and contacts the disc to form an electrical circuit therebetween. The brush may in turn be connected via a short conductor wire and grounded to the steel structure of the nacelle 16. Alternatively, the brush may be stationary with respect to the hub 12. Instead of a disc as schematically illustrated in FIG. 2, a surface of the main shaft 14 extending between the hub 12 and the nacelle 16 may be used to contact the brush. As with brush assembly 50, many different arrangements for the brush assembly 47 are possible and may be present on a wind turbine.

To conduct the lighting current from the nacelle steel structure to the down tower section 6 and around a yaw bearing 54, a third brush assembly 56 may be used. The brush assembly 56 may be similar to the brush assemblies 50 and 47 or, alternatively, the lightning current may be conducted from the nacelle steel structure to the down tower section 6 with the help of a drip/twist loop instead of with a brush connection. Within the down tower section 6, several short grounding straps may be employed to ensure an adequate electrical grounding connection between each tower section, as illustrated schematically in FIG. 2. In at least some embodiments, an inside wall surface of the down tower section 6 may itself be employed as an electrical conductor for conducting the lighting current from the nacelle steel structure to the down tower section. Furthermore, the bottom tower section may be connected to the earth grounding grid 44 via a few short grounding straps, as shown schematically in FIG. 2. The earth grounding grid 44 may have rods that may be long and sunk deep into the ground through and connected to the foundation reinforcing steel, to allow any current to dissipate into the ground. Although the earth grounding grid 44 has been used for grounding the lighting current in the present embodiment, in at least some other embodiments, a different grounding system may be used. Additionally, other configurations are possible for the LPS 38. As mentioned above, instead of brush assemblies, twist cables or slip rings may be used. Similarly, instead of using structural steel as a conductor in part of the system, cables may be used.

To ensure that the LPS 38 is in proper functioning order to effectively protect the wind turbine 2 from any lightning strikes, the LPS may be periodically inspected using the LPS testing system 40. The LPS testing system 40 may provide for an automatic, or remote, inspection of at least a portion of the LPS 38 without requiring on-site technicians and without deploying test equipment. Similar to the LPS 38, although the LPS testing system 40 has been shown and described with respect to only one of the plurality of blades 10, a separate leg of the LPS testing system 40 on each of the plurality of the blades 10 may be present.

Each of the legs of the LPS 38 from the respective lightning receptor(s) 42 to the earth grounding grid 44 may be inspected consecutively, one at a time, by establishing an LPS testing circuit and testing for continuity between the lightning receptor(s) and the earth grounding grid through the LPS testing system 40, as described further below. Similar to the LPS 38, the LPS testing system 40 may extend from the lightning receptor(s) 42 to the earth grounding grid 44. The combination of one leg of the LPS testing system 40 and one leg of the LPS 38 may form the LPS testing circuit for testing continuity in the LPS.

The LPS testing system 40 may include an LPS test controller 64. In FIG. 2, the LPS test controller 64 is illustrated schematically as being positioned in the bottom of the down tower section 6. Those of ordinary skill in the art will understand that it may be positioned in alternate locations on the wind turbine 2, and may also be co-located in an existing electrical or control cabinet with other existing equipment. One lead conductor 65 of the LPS test controller 64 may be electrically connected to the earth grounding grid 44. Alternatively, for example if the LPS test controller 64 is co-located in an existing cabinet with other equipment, the lead conductor 65 may be electrically connected to an existing ground wire (which itself ultimately traces a connection back to the earth grounding grid 44).

Another lead conductor 63 may travel up through the down tower section 6 towards the nacelle 16 and may pass around the yaw bearing 54 by forming a drip/twist loop, in a known manner. Alternatively, the lead conductor 63 may pass from the down tower section 6 into the nacelle 16 through a slip ring, or with other arrangements. But it must not be grounded, or else the intended LPS testing system 40 to be formed will be short-circuited. The lead conductor 63 may then pass from the nacelle 16 into the hub 12 via a slip ring 68 in a known manner. A brush assembly could be another option, but again it must remain ungrounded. In contrast to the LPS 38, which uses relatively heavy gauge conductors to carry the lightning currents, the lead conductors 63 and 65 in the LPS test system 40 may be constructed of a light gauge conductive material because they need only carry and should only carry very small currents and voltages. At least inside of the blades 10, it may be desirable to heavily insulate the lead conductor 63 positioned therein so that it does not become a current carrier for any stray lightning stringers that find their way inside of the blade.

From the hub 12, the lead conductor 63 may pass into the blade 10 via a make/break connection 66. The make/break connection 66 may be a roller and pad type system (e.g., a roller that contacts an opposite facing pad only at a certain range of pitch positions of the blade 10), a brush and pad type system (e.g., a brush that contacts an opposite facing pad at a certain range of pitch positions of the blade), or possibly a pair of transformers that line up only at a certain pitch angle (e.g., one transformer with an input coil mounted to the hub 12 and another transformer with an output coil mounted on the blade) or possibly a switch of some kind. Other types of the make/break connection 66 may be employed as well in other embodiments.

The make/break connection 66 may be employed for completing the LPS testing circuit via the LPS testing system 40 and to send a test current signal in the lightning receptor(s) 42 to test continuity in the LPS 38 of that leg. For example, when the roller and pad, or the brush and pad, or the two transformer coils, are aligned and in contact, a test current signal from the LPS test controller 64 may bridge through the make/break connection 66 over the pitch bearing 48 and into the lightning receptor(s) 42. The test current signal from the lightning receptor(s) 42 may then transfer to the earth grounding grid 44 using the same pathway that an actual lightning strike would take in the LPS 38 (from the lightning receptor(s) to the blade and through the brush assemblies 50, 47 and 56 into the down tower section 6 and to the earth grounding grid 44). The make/break connection 66 is not only a way to make a complete the LPS testing circuit for conducting the test current signal for testing the LPS 38, it is also a way to ensure that the connection is not made during normal operation of the wind turbine 2, as described in greater detail below. During normal operation, the LPS testing system 40 is kept open to prevent the LPS testing system from carrying any lightning current. Although the LPS testing system 40 has been described above as following a specific path from the lightning receptor(s) 42 to the earth grounding grid 44, it will be understood that the exact manner of construction and pathway for the lead conductors 63 and 65 may vary depending upon the location of the LPS test controller 64 and other design factors.

Thus, the continuity within the LPS 38 may be tested by establishing an LPS testing circuit by completing the connection of the LPS testing system 40 through the make/break connection 66 and introducing a test current at the lightning receptor(s) 42 of the blade 10. By knowing the value of the test current, a voltage differential between the lightning receptor(s) 42 and the earth grounding grid 44 of the LPS 38 may be measured to calculate a cumulative or total resistance in that leg. If the cumulative resistance is below a specified threshold, then the LPS 38 for that leg may pass the continuity test and also the inspection. If the resistance, on the other hand, is out of the normal specified threshold range, then that leg may not pass the continuity test and it may be an indication of some problem (such as damaged parts, wear and tear, etc.) within the LPS 38.

The test current is created in the LPS test controller 64. The LPS test controller 64 may draw its power from a transformer of the TCU 30 in the nacelle 16, or from a PCU transformer in the hub 12, or from somewhere in the down tower section 6, depending upon the location of the LPS test controller 64. As previously mentioned, the LPS test controller 64 is illustrated herein as being positioned in the lower portion of the tower, but could alternatively be positioned in the nacelle 16 or in the hub 12. In other embodiments, the LPS test controller 64 may supply a fixed voltage and the current may be measured using a current meter, such as, an ammeter. The LPS test controller 64 may combine a power supply unit with a voltage meter to both provide a test current signal and to measure a potential difference (and calculate the resistance) between the lightning receptor(s) 42 and the earth grounding grid 44 of the LPS 38. Alternatively, and if LPS test controller 64 includes a voltage source instead of a current source, the voltage source may be physically separated from the current sensor; the voltage source may be positioned up tower in the hub 12, while the current sensor could be positioned in nacelle 16, or any other combination may be possible to customize the arrangement according to the existing design parameters of the turbine.

Referring still to FIG. 2, the make/break connection 66 may be arranged so that it closes the LPS testing system 40 only at discrete blade pitch angle positions. Generally speaking, the make/break connection 66 may be aligned only when the pitch angle of the blade 10 being tested is outside of the normal pitch angle range. For instance, the normal pitch angle may range between zero degrees (0°) and ninety degrees (90°). In order to inspect the LPS 38 for the blades 10, the pitch angle of that blade may be changed to lie outside of the normal pitch angle range and the contact system 66 will only close the LPS testing system at this pitch angle that is outside the normal working range. In at least some embodiments, for example, a pitch angle of ninety five degrees (95°) may be employed for testing the LPS 38 of the blades 10. In other embodiments other pitch angles outside of the normal pitch angle range may be employed as well.

By virtue of changing the pitch angle of the blade 10 for which the LPS 38 is being inspected to lie outside of the normal pitch angle range, it may be assured that the LPS testing system 40 is not closed when the wind turbine 2 is operating to generate power. If the LPS testing system 40 is closed when the wind turbine 2 is in an operational state (e.g., generating power), and if lightning strikes the wind turbine, then the lightning current may be transmitted via the lead conductor 63 positioned inside of the blade 10 or in the tower of the LPS testing system. Given that the lead conductor 63 and other components of the LPS testing system 40 are designed to only carry smaller test current values, the LPS testing system 40 may be damaged if current from a lightning strike passes through it. Thus, the positioning of a blade at the necessary pitch angle position to close the LPS testing system 40 through the make/break connection 66 and the inspection of the LPS 38 may typically only be performed when the wind turbine 2 is in a stand-by or maintenance mode of operation, i.e., not when it is generating power.

When it is desired to test the LPS 38, the TCU 30 may command the PCU to pitch one blade at a time to the required pitch position, outside of the normal working range. Pitching one blade 10 at a time outside of the normal pitch angle working range will result in a pitch error, i.e. a differential pitch position between the blades. If the wind turbine 2 is only operating in a stand-by or maintenance mode of operation, this intentional pitch error will not lead to any damaging effects.

The blade 10 which contains the leg of the LPS 38 being inspected need not be locked in a six o'clock position during inspection, which is an advantage over manual inspection techniques. It is undesirable to lock the rotor from rotating. The test can be performed while the hub 12 is rotating.

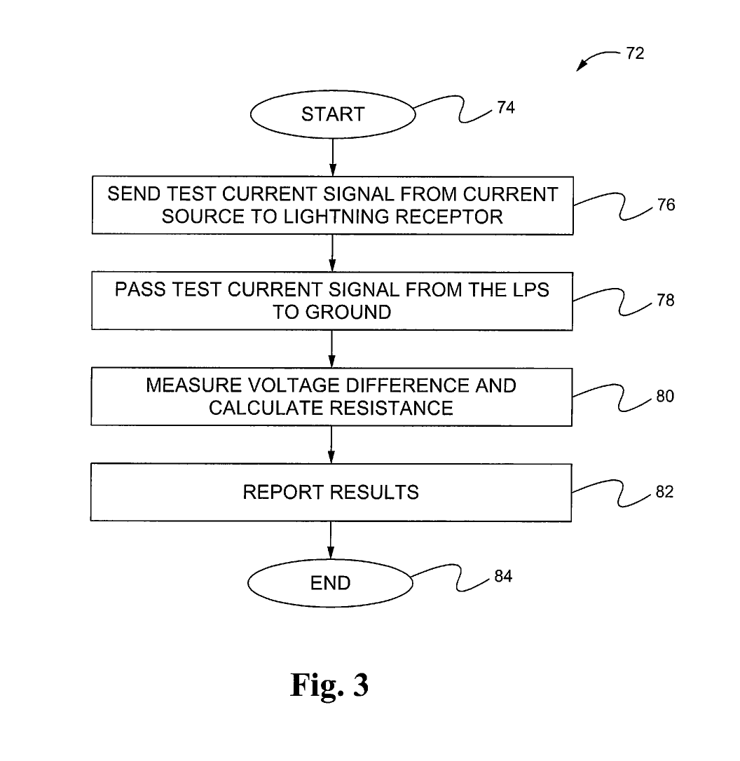

Turning now to FIG. 3, a flowchart 72 outlining steps that may be performed in inspecting the LPS 38 using the LPS testing system 40 are outlined, in accordance with at least some embodiments of the present disclosure. As described above, the LPS 38 may be inspected in part by performing a continuity test established by completing the LPS testing circuit through the LPS testing system 40. To reach a starting step 74, it may be necessary for the wind turbine 2 to enter its standby or maintenance mode of operation, or equivalent, where the wind turbine is not making power and the blades 10 are pitched out of the wind and the structures and components are not loaded. Then, the blade 10 which has the leg of the LPS 38 to be tested is moved to the pitch angle position or range where the make/break connection 66 closes the LPS test system 40 and completes the LPS testing circuit. After starting at the step 74, the continuity test may be performed in steps 76-82.

At the steps 76 and 78, a test current signal may be transmitted through the LPS testing system 40 including the lead conductors 63 and 65, the make/break connection 66 and other components of the LPS testing system, the LPS 38 of the leg of the blade 10 to be tested and to the earth grounding grid 44. Then, at the step 80, the voltage difference between the lead conductors 63 and 65 is measured (or may be measured elsewhere in the circuit). Now, knowing the test current value and the voltage difference, the total resistance of that leg of the LPS 38 may be calculated. Again, and as described above, if the resistance is within a specified threshold, then the LPS 38 for that leg may pass the continuity test. If the resistance is outside the specified threshold, then the LPS for that leg may not pass the continuity test.

The measured resistance might be affected by some of the test current flowing through the pitch bearing 48, the main shaft bearing 49, and the yaw bearing 54 instead of flowing completely through the brush assemblies 50, 47 and 56, respectively. Any test current passing through these bearings creates an error in the continuity test because it is the resistance of the intended lightning path that needs to be measured, not the resistance through any leak path through these bearings. Any error that may result from the test current taking this alternative route will likely be small as the resistance through the pitch bearing 48, the main shaft bearing 49, and the yaw bearing 54 is typically at all times relatively high compared to their corresponding brush assemblies 50, 47, and 56. Although this error may be small, it may be possible to measure this error and factor it out by measuring the test current with a current sensor through each of the brush assemblies 50, 47 and 56. Knowing the test current that is leaking through these bearings would allow for a calculation to be made to correct for the error in measured resistance.

Also, the total calculated resistance may reflect the resistance of the test signal current as it passes through the lead conductors 63 and 65, through the nacelle/gearbox slip ring 68 and other components of the LPS testing system 40. This error may only tend to overestimate the resistance of the LPS 38, so it may be unimportant, considering that overestimating the resistance may be safer than underestimating it. However, if the resistance is too high, a technician may have to determine if there is a hardware problem somewhere in the LPS testing system in the slip ring 68 or conductors 63 and 65 or other LPS testing system 40 components, or if the resistance is too high due to an actual problem within the LPS 38. In at least some embodiments, the errors resulting from the test signal flowing through the first and the second leads 63 and 65, the nacelle/gearbox slip ring 68, etc., may be factored out by arranging for a test current to loop through the nacelle/gearbox slip ring and all other LPS Testing System 40 components twice before conducting the continuity test, and then factoring out the measured resistance of all the LPS Testing System 40 components, in a known manner.

Thus, by knowing the test current value and measuring the voltage difference around the current source, the continuity of the LPS 38 may be confirmed. The calculated resistance may be reported to a remote monitoring diagnostics center (RMDC) and/or used to create flags in case the resistance measurement indicates that any particular leg of the LPS 38 is malfunctioning at the step 82. The process then ends at a step 84.

The steps 76-82 may be repeated for each of the blades 10 of the wind turbine 2. The results of the continuity test may be reported to the RMDC for all the blades together or one-by-one as the test for each blade is performed and completed. A similar test may be performed for the lightning rod 28 located on the nacelle 16 to ensure that the lightning rod is in proper functioning order. It will also be understood that the continuity test may be performed automatically periodically and even remotely as desired from the RMDC. Additionally, the LPS testing system 40 for inspecting the LPS 38 may be retrofitted in existing wind turbines that currently undergo manual inspection of the LPS.

Other advantages of the above described automatic inspection system may allow performing the continuity test when the rotor is rotating, i.e. it can test the resistance of the brush assembly 47 while the hub is turning, which might be a more accurate measurement or testing of the system. The automatic inspection technique may also test the resistance during pitch bearing movement if the contact area of the contactor system is large enough to allow pitch bearing movement during the test. Likewise, the wind turbine could be caused to yaw during the test of the LPS system 38 to test the resistance of the brush assembly 56 while in motion.

While only certain embodiments have been set forth, alternatives and modifications will be apparent from the above description to those skilled in the art. These and other alternatives are considered equivalents and within the spirit and scope of this disclosure and the appended claims.

We claim:

1. A method for automatically inspecting a lightning protection system on a wind turbine, comprising:
providing a wind turbine having (a) a plurality of blades mounted to a hub; (b) a lightning receptor on a tip of each of the plurality of blades; (c) a lightning protection system extending from each of the lightning receptor to an earth grounding grid; and (d) a conductor that is part of a testing system extending from at least inside the hub, through the inside of at least one of the plurality of blades and connecting to the lightning receptor, the conductor completing a circuit extending from the lightning receptor to the earth grounding grid;
introducing a test signal into the testing system for a leg of the lightning protection system to be tested; and
determining an electrical continuity in the circuit using the test signal.

2. The method of claim 1, further comprising reporting results to a remote monitoring diagnostics center.

3. The method of claim 1, wherein determining electrical continuity comprises;
measuring a potential difference between the lightning receptor of the at least one of the plurality of blades and the earth grounding grid; and
calculating a total resistance in the leg of the lightning protection system being tested.

4. The method of claim 3, wherein the lightning protection system corresponding to the lightning receptor of the at least one of the plurality of blades is said to pass inspection when the total resistance falls within a specified threshold.

5. The method of claim 1, wherein the test signal is drawn from a current source located on the wind turbine.

6. The method of claim 1, wherein the test signal is introduced into the lightning receptor of the at least one of the plurality of blades only when a make/break connection of the testing system is aligned.

7. The method of claim 6, wherein the make/break connection is aligned automatically when the at least one of the plurality of blades being inspected is pitched to an angle outside of a normal pitch angle range.

8. The method of claim 7, wherein the make/break connection is aligned when the wind turbine is in a stand-by mode.

9. The method of claim 1, further comprising:
disconnecting the test current signal from the at least one of the plurality of blades;
creating a pitch error in another one of the remaining of the plurality of blades; and
connecting the test current signal to the another one of the remaining of the plurality of blades.

10. An inspection system for a lightning protection system on a wind turbine, the inspection system comprising:
a lightning protection system extending from a lightning receptor on a blade of the wind turbine to an earth grounding grid; and
a testing system connected to the lightning receptor on the blade of the wind turbine and to the earth grounding grid to form a testing circuit, the testing system being located generally inside of the wind turbine.

11. The inspection system of claim 10, wherein the testing system comprises a first conductor extending between a test signal source and the lightning receptor on the blade of the wind turbine via a make/break connection.

12. The inspection system of claim 11, wherein the testing system further comprises a second conductor extending from the test signal source to the earth grounding grid.

13. The inspection system of claim 10, wherein the testing system passes through a slip ring in a nacelle of the wind turbine and extends into a down tower section.

14. The inspection system of claim 10, wherein the make/break connection is automatically aligned when the blade has a pitch error.

15. The inspection system of claim 10, wherein at least one of the lightning receptor is provided on each of the blades of the wind turbine.

16. The inspection system of claim 10, wherein the lightning protection system comprises an electrical conductor extending from the lightning receptor across a plurality of lightning brushes to a down tower section of the wind turbine.

17. A method for performing a continuity test on a lightning protection system on a wind turbine, the method comprising;
connecting a testing system to a lightning receptor mounted on the exterior, distal end of a rotor blade of a wind turbine on one end, and connecting the testing system to an earth grounding grid on the other end, the earth grounding grid also connected to the lightning receptor to form a lightning protection system for conducting current from lightning strikes to the earth; and
simultaneously sending a test signal from the testing system between the lightning receptor and the earth grounding grid to test continuity while allowing the rotor of the wind turbine to rotate.

18. The method of claim 17, wherein the testing system comprises aligning a make/break connection of the testing system, the make/break connection becoming aligned when a pitch angle of the rotor blade is set at an alignment position.

19. The method of claim 18, wherein the alignment position is outside of the normal range of pitch angles when the wind turbine is operating.

20. The method of claim 17, further comprising testing a second rotor blade of the wind turbine by disconnecting the testing system from the lightning receptor through misaligning a make/break connection, and aligning a second alignment system corresponding to a second rotor blade to connect the testing system to a second lightning receptor located on an exterior, distal end of the second rotor blade.
